(19) United States
(12) Patent Application Publication
(10) Pub. No.: US 2026/0001564 A1
(43) Pub. Date: Jan. 1, 2026

(54) Ecological Driving Oriented to Complex Traffic Scenarios for Connected Energy Vehicles

(71) Applicant: Chongqing University, Chongqing (CN)

(72) Inventors: Xiaosong Hu, Chongqing (CN); Jin Zeng, Chongqing (CN); Jiacheng Li, Chongqing (CN); Jie Han, Chongqing (CN); Hanghang Cui, Chongqing (CN); Cheng Dai, Chongqing (CN); Yumeng Cong, Chongqing (CN); Chuang Pu, Chongqing (CN); Zhiqiang Jiang, Chongqing (CN)

(21) Appl. No.: 19/184,147

(22) Filed: Apr. 21, 2025

(30) Foreign Application Priority Data
Jul. 1, 2024 (CN) 202410868935.4

(51) Int. Cl. B60W 50/00; B60W 20/15; B60W 40/107

(52) U.S. Cl. CPC B60W 50/0098; B60W 20/15; B60W 40/107; B60W 2050/0028; B60W 2520/10; B60W 2520/105; B60W 2552/10; B60W 2554/4041; B60W 2554/4042; B60W 2554/802; B60W 2555/60

(57) ABSTRACT

The present invention relates to an economic driving strategy for hybrid electric vehicles in complex traffic scenarios based on deep reinforcement learning, belonging to the field of new energy vehicles. The method comprises: constructing an interactive multi-lane multi-traffic signal training scenario: describing longitudinal motion of vehicles in the training scenario using vehicle kinematic models; simplifying lane-changing processes of vehicles into transient states; controlling surrounding vehicles through rule-based decision models to establish environmental interactivity; building a maximum entropy deep reinforcement learning-based decision model containing: state space, action space, reward function, policy model critic model, and experience replay buffer; establishing safety constraints for the target vehicle, including: longitudinal acceleration safety constraints, lateral lane-changing decision safety constraints, preventing collision risks and traffic regulation violations; training the maximum entropy deep reinforcement learning-based decision model. The invention enhances fuel economy of autonomous vehicles through deep reinforcement learning techniques.

### Technical Field

The invention belongs to the field of new energy vehicles, and relates to a deep reinforcement learning-based energy-efficient driving method for connected electric vehicles in complex traffic scenarios with multiple lanes and traffic signals.

### Background Art

With the rapid development of urban transportation, traffic congestion and environmental pollution have become increasingly severe. Hybrid electric vehicles (HEVs), due to their high fuel efficiency and low emissions, serve as an important solution. However, in complex urban traffic environments with multiple lanes and traffic signals, fully leveraging the energy-saving potential of HEVs remains a challenge.

Current energy-efficient driving strategies for HEVs primarily rely on predefined driving rules. While these rules are simple to implement and computationally efficient, they lack flexibility and cannot dynamically adapt to complex and variable traffic conditions, resulting in suboptimal fuel efficiency and driving comfort. Mathematical models and optimization algorithms have been used to find optimal driving strategies to maximize fuel economy and minimize emissions. Although these methods outperform rule-based approaches, they require significant computational resources, are difficult to deploy in real-time, and depend heavily on accurate traffic prediction models. Learning-based methods can automatically generate generalized driving experiences from data, showing advantages in adaptability and robustness. However, existing learning-based methods focus on simple highway scenarios or safety considerations, making them unsuitable for energy efficiency in interactive multi-lane, multi-traffic signal environments.

Thus, there is an urgent need for a new energy-efficient driving strategy for connected electric vehicles in complex traffic scenarios.

### SUMMARY OF THE INVENTION

The present invention aims to provide an energy-efficient driving method for connected new energy vehicles in complex traffic scenarios. By leveraging interactive training data from a simulated environment and incorporating features of multi-lane, multi-traffic signal roads, the method improves the economic efficiency, comfort, and stability of deep reinforcement learning-based driving strategies for hybrid electric vehicles.

In order to achieve the aforementioned objectives, the present invention provides the following technical solutions:
1. An ecological driving method oriented to complex traffic scenarios for connected energy vehicles, comprising:
S1. constructing an interactive multi-lane, multi-traffic signal simulation training environment, wherein:
longitudinal motion of vehicles is described by a kinematic model
lane-changing is simplified as a transient process;
traffic signals operate in multiple phases;
rule-based longitudinal acceleration decision models and lane-changing decision models for surrounding vehicles are established to enable reactive responses to traffic environment changes;
S2. building a maximum entropy deep reinforcement learning (DRL) decision model, including:
a state space, an action space, and a reward function;
setting structures of a policy model and a critic model, wherein the policy model maps states to actions, and the critic model evaluates actions generated by the maximum entropy DRL model.
S3. applying safety constraints to the target vehicle, including:
longitudinal motion safety constraints;
lane-changing action safety constraints.
S4. training the maximum entropy DRL decision model.

Furthermore, in step S1, the kinematic model is expressed as:

$$[ \begin{matrix}{x}^{′} \\ {v}^{′}\end{matrix} ] = [ \begin{matrix}0 & 1 \\ 0 & 0\end{matrix} ] [ \begin{matrix}x \\ v\end{matrix} ] + [ \begin{matrix}0 \\ 1\end{matrix} ] a$$

where x and v represent the vehicle's longitudinal position and velocity, x′and v′ represent the first derivatives of longitudinal position and velocity, respectively, and a represents acceleration.

Furthermore, in step S1, the rule-based longitudinal acceleration decision model for surrounding vehicles comprises:
1) calculating a maximum safe speed v_{safe}:

$${v}_{safe} = min ( \sqrt{( \frac{{v}_{l}^{2}}{2 {b}_{max}} + {d}_{gap} ) \cdot 2 {b}_{max}} , \sqrt{2 {b}_{max} {d}_{tl}} )$$

where vₗ is the preceding vehicle's speed, bₘₐₓ is the vehicle's maximum deceleration, d_{gap} is the inter-vehicle distance, and dₜₗ is the distance to the traffic signal;
2) Outputting the vehicle's acceleration a based on v_{safe}, road speed limit, and vehicle maximum acceleration:

$${v}_{des} = min ( {v}_{max} , v + {a}_{max} Δ t , {v}_{safe} )$$

$${v}^{′} = min ( 0 , {v}_{des} )$$

$$a = {v}^{′} - v$$

where v_{des} is the expected speed, vₘₐₓ is the road speed limit, v is the vehicle's current speed, aₘₐₓ is the maximum acceleration, Δt is the time step, and v′ is the final target speed.

Furthermore, in step S1, the rule-based lane-changing decision model for surrounding vehicles comprises:
1) acquiring lane information and surrounding vehicle data, and screening lane sets Lᵥₐₗ with lane-changing conditions via conditional judgments:

$${L}_{val} = \{ {l}_{i} , … \}$$

$${δ}_{i} = \{ \begin{matrix}1 & \frac{{v}_{self}^{2}}{2 {d}_{max}} \leq \frac{{v}_{l}^{2}}{2 {d}_{max}} + {d}_{gap} ⋂ \frac{{v}_{f}^{2}}{2 {d}_{max}} \leq \frac{{v}_{self}^{2}}{2 {d}_{max}} + {d}_{gap} \\ 0 & \frac{{v}_{self}^{2}}{2 {d}_{max}} > \frac{{v}_{l}^{2}}{2 {d}_{max}} + {d}_{gap} ⋃ \frac{{v}_{f}^{2}}{2 {d}_{max}} > \frac{{v}_{self}^{2}}{2 {d}_{max}} + {d}_{gap}\end{matrix}$$

where lᵢ is the lane number, δᵢ indicates whether lane lᵢ meets lane-changing conditions, dₘₐₓ is the maximum deceleration, and v_{f} is the rear vehicle speed in lane lᵢ;
2) determining feasible lanes Lₜₐᵣ based on the destination and combining with Lᵥₐₗ to obtain final executable lanes L:

$$L = {L}_{tar} ⋂ {L}_{val}$$

3) determining the final lane-changing action lₜₐᵣ based on average lane speeds v̅ᵢ:

$$S = \{ ( {l}_{1} , {\overline{v}}_{1} ) , … , ( {l}_{i} , {\overline{v}}_{i} ) \} , s . t . {l}_{i} ∈ L$$

$${l}_{tar} = \{ {l}_{i} \vert {\overline{v}}_{i} = min \{ \overline{v} \vert ( {l}_{i} , {\overline{v}}_{i} ) ∈ S \} \}$$

where S is the set of lane numbers lᵢ and their corresponding average speeds v̅ᵢ.

Furthermore, wherein step S2:
the state space S is defined as:

$$S = [ {S}_{e} , {S}_{others} , {S}_{tl} , {S}_{flow} ]$$

$$s . t .$$

$${s}_{e} = [ {l}_{e} , {v}_{e} , {a}_{e} ]$$

$${S}_{others} = [ {d}_{0} , {l}_{0} , {v}_{0} , {d}_{1} , {l}_{1} , {v}_{1} , … , {d}_{5} , {l}_{5} , {v}_{5} ]$$

$${S}_{tl} = [ {d}_{tl} , {t}_{red} , {t}_{green} , {t}_{yellow} ]$$

$${S}_{flow} = [ {\overline{v}}_{0} , {ρ}_{0} , {\overline{v}}_{1} , {ρ}_{1} , {\overline{v}}_{2} , {ρ}_{2} ]$$

where: Sₑ is the target vehicle information, Sₒₜₕₑᵣₛ is the surrounding vehicle information, Sₜₗ is the front traffic signal light information, S_{flow} is the front traffic flow information; lₑ, vₐaₑ respectively denote the lane where the target vehicle is located, its velocity, and acceleration; dᵢ, lᵢ, vᵢ respectively denote the inter-vehicle distance between the surrounding vehicles and the target vehicle, the lanes where the surrounding vehicles are located, and the speeds of the surrounding vehicles; dₜₗ represents the distance to the front traffic signal light, while t_{red},t_{green}, t_{yellow} respectively denote the remaining duration of the red light, green light, and yellow light; v̅ⱼ, ρj represent the average traffic flow speed and traffic density of respective lanes.
the action space is defined as:

$$A = [ a , l ]$$

$$s . t . a ∈ [ - 4.5 , 2 \text{.6} ] m / {s}^{2} , l ∈ [ 0 , 2 ]$$

where l is the target lane.

The reward function is defined as:

$$R = {w}_{v} {R}_{v} + {w}_{a} {R}_{a} + {w}_{{a}^{′}} {R}_{{a}^{′}} + {w}_{eco} {R}_{eco} + {w}_{lc} {R}_{lc}$$

where wᵥ, wₐ, w_{a′}, w_{eco}, w_{lc} are weighting coefficients, Rᵥ rewards traffic efficiency, Rₐ and R_{a′} penalize acceleration and jerk, R_{eco} penalizes energy consumption, and R_{lc} penalizes lane changes.

Furthermore, wherein in step S3, the longitudinal motion safety constraints comprise:
1) calculating the maximum safe speed v_{safe}:

$${v}_{safe} = min ( \sqrt{( \frac{{v}_{l}^{2}}{2 {b}_{max}} + {d}_{g a p} ) \cdot 2 {b}_{max}} , \sqrt{2 {b}_{max} {d}_{tl}} )$$

2) calculating the maximum safe acceleration a_{safe}:

$${s}_{safe} = {v}_{safe} - v$$

3) comparing the acceleration a_{policy} output by the DRL model with a_{safe}, and selecting the smaller value as the final acceleration control a:

$$a = min ( {a}_{policy} , {a}_{safe} ) .$$

Furthermore, wherein step S3, the lane-changing action safety constraints comprise:
judging the target lane l_{policy} output by the DRL model:

$${δ}_{policy} = \{ \begin{matrix}1 & \frac{{{v}_{self}}^{2}}{2 {d}_{max}} \leq \frac{{{v}_{l}}^{2}}{2 {d}_{max}} + {d}_{gap} ⋂ \frac{{{v}_{f}}^{2}}{2 {d}_{max}} \leq \frac{{{v}_{self}}^{2}}{2 {d}_{max}} + {d}_{gap} \\ 0 & \frac{{{v}_{self}}^{2}}{2 {d}_{max}} > \frac{{{v}_{l}}^{2}}{2 {d}_{max}} + {d}_{gap} ⋃ \frac{{{v}_{f}}^{2}}{2 {d}_{max}} > \frac{{{v}_{self}}^{2}}{2 {d}_{max}} + {d}_{gap}\end{matrix}$$

where δ_{policy} indicates whether lane l_{policy} meets lane-changing conditions. If δ_{policy}=1, execute the lane change; otherwise, prohibit it.

Furthermore, wherein in step S4 comprises:
S41. initializing the maximum entropy DRL decision model, including hyperparameters of the policy model and critic model;
S42. adding the target vehicle to the training environment, generating interactive training data (sₜ, aₜ, rₜ, sₜ₊₁) under safety constraints, and storing the data in an experience replay buffer;
S43. extracting training data from the buffer and updating two critic models via gradient descent:

$${∇}_{{θ}_{i}} \frac{1}{\vert M \vert} {\sum }_{( {s}_{t} , {a}_{t} , {r}_{t} , {s}_{t + 1} ) ∈ M} {( {Q}_{i} ( {s}_{t} ) - y ( {r}_{t} , {s}_{t + 1} ) )}^{2} , for i = 1 , 2$$

$$y ( {r}_{t} , {s}_{t + 1} ) = {r}_{t} + γ ( {min}_{j = 1 , 2} {Q}_{tar - j} ( {s}_{t + 1} ) - α log π ( {\tilde{a}}_{t + 1} \vert {s}_{t + 1} ) , {\tilde{a}}_{t + 1} \sim π ( \cdot \vert {s}_{t + 1} ) )$$

where M is the number of sampled data points, |M | is the batch size, sₜ,aₜ,rₜ represent the state, action, reward, and next state at time t, Qᵢ is the i-th critic model, θᵢ is its parameters, Qₜₐᵣ₋ⱼ is the j-th target critic, π(·|sₜ) is the policy, ãₜ₊₁ is the next action sampled from sₜ₊₁, α is the temperature coefficient, and γ is the discount factor;
S44. updating the policy model via gradient descent:

$${∇}_{ψ} \frac{1}{\vert M \vert} {\sum }_{{s}_{t} ∈ M} ( {min}_{j = 1 , 2} {Q}_{tar - j} ( {s}_{t} ) - α log π ( {\tilde{a}}_{t} \vert {s}_{t} ) )$$

where Ψ is the policy parameters; ãₜ is the action sampled from sₜ;

S45. updating the temperature coefficient via gradient descent:

$${∇}_{α} \frac{1}{\vert M \vert} {\sum }_{{s}_{t} , {a}_{t} ∈ M} ( - α log π ( {a}_{t} \vert {s}_{t} ) - α {H}_{0} )$$

where H₀ is the target entropy;
S46. updating the two target critic models:

$${θ}_{tar , i} = {ρθ}_{tar , i} + ( 1 - ρ ) {θ}_{i} , for i = 1 , 2$$

where ρ is the soft update coefficient; θ_{tar,i} is the parameters of the target critic Qₜₐᵣ₋ᵢ, and θᵢ is the parameters of the critic model Qᵢ;
S47. iteratively training the maximum entropy DRL model until convergence. If performance is unsatisfactory, optimizing hyperparameters and the reward function, and returning to S41.

The beneficial effects of the present invention lie in:
1) The present invention designs a highly stochastic and interactive multi-lane multi-traffic-signal training environment, making the training data more aligned with real-world traffic scenario characteristics, which facilitates improving the decision-making performance of reinforcement learning decision-making models in real traffic scenarios.
2) The present invention designs a hybrid electric vehicle economic driving strategy based on maximum entropy deep reinforcement learning for complex traffic scenarios. It extracts key environmental information as input for complex traffic scenarios, uses acceleration and target lane as outputs, and obtains a learning-based decision-making model that enhances both fuel economy and driving comfort during hybrid electric vehicle operation.
3) The present invention designs a rule-based safety constraint that ensures driving safety, preventing dangerous behaviors such as collisions and traffic rule violations during vehicle operation.
4) The present invention designs an effective reward function for hybrid electric vehicles in complex traffic scenarios, enabling vehicles to maintain efficiency, economy, and comfort during operation.

Other advantages, objectives, and features of the present invention will be partially elucidated in the following description. To some extent, they will become apparent to those skilled in the art through subsequent investigation of the following context, or may be learned through practice of the invention. The objectives and other advantages of the present invention may be realized and attained through the description herein.

### BRIEF DESCRIPTION OF THE DRAWINGS

To clarify the objectives, technical solutions, and advantages of the present invention, preferred embodiments will be described in detail below with reference to the accompanying drawings, in which:

FIG. 1 is a schematic logic diagram of the economic driving strategy according to the present invention;

FIG. 2 is a schematic structural diagram of the reinforcement learning decision-making and planning model;

FIG. 3 is a schematic diagram of the interactive multi-lane multi-traffic-signal training environment;

FIG. 4 is a schematic diagram of a multi-lane multi-traffic-signal scenario;

FIG. 5 is a schematic diagram of the update training process for the reinforcement learning decision-making and planning model;

FIG. 6 is a schematic flowchart of the method according to the present invention.

### DETAILED DESCRIPTION OF THE EMBODIMENTS

The following describes embodiments of the present invention through specific examples. Those skilled in the art may readily understand other advantages and effects of the invention from the contents disclosed herein. The invention may also be implemented or applied through different embodiments, and various details in this specification may be modified or altered based on different perspectives and applications without departing from the spirit of the invention. It should be noted that the diagrams provided in the following embodiments illustrate the basic concepts of the invention schematically. Unless conflicting, the embodiments and their features may be combined.

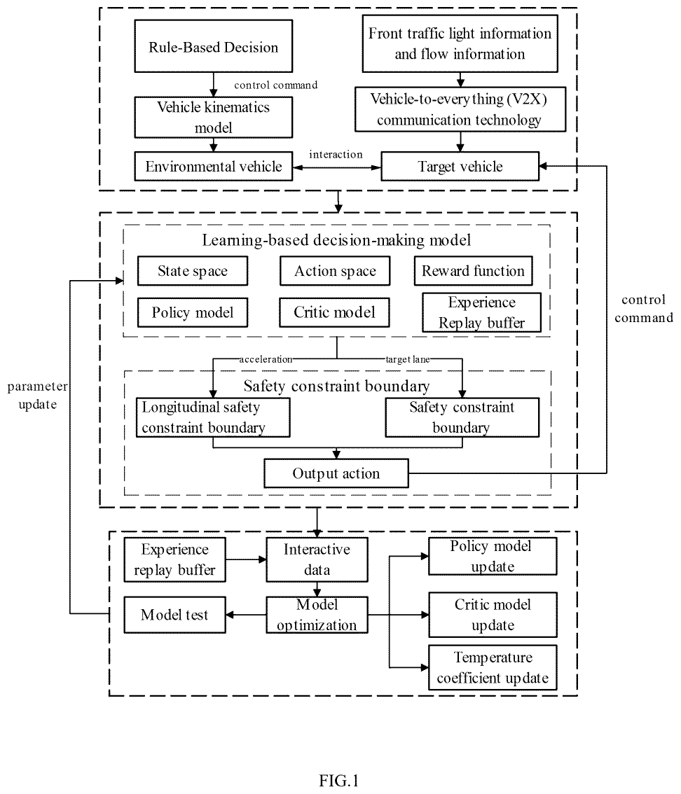

Referring to FIGS. 1-6, the present invention provides a reinforcement learning-based economic driving method for connected new energy vehicles in complex traffic scenarios. Considering interactive behaviors between vehicles in real traffic environments, an interactive training environment is constructed to provide interactive training data. Simultaneously, to meet the requirements of fuel economy and driving efficiency for autonomous vehicles, a maximum entropy deep reinforcement learning-based decision-making method with improved stability, efficiency, and sample utilization is proposed. As shown in FIGS. 1 and 6, the method specifically includes the following steps:

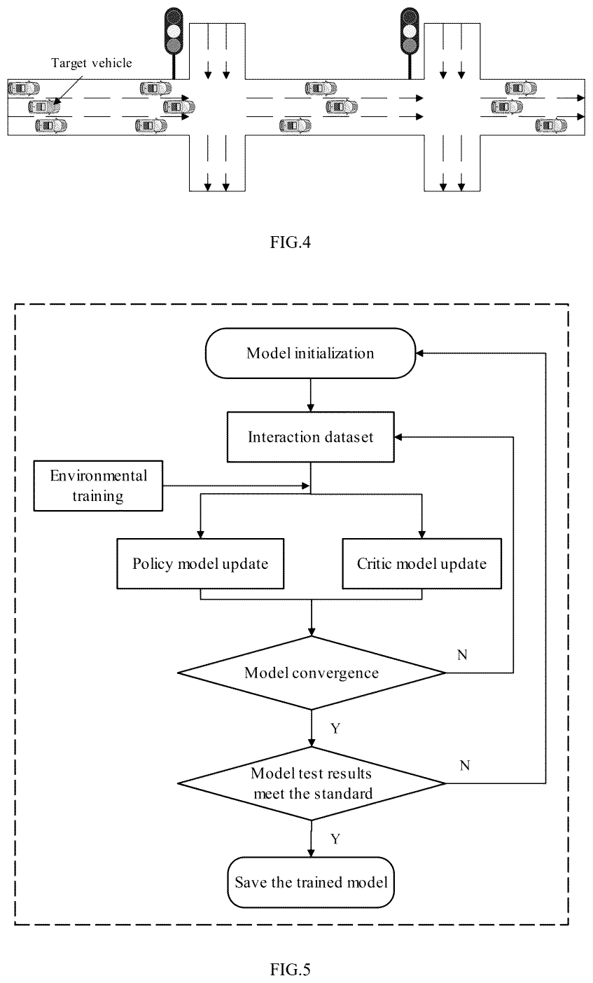

Step S1: Construct an interactive multi-lane multi-traffic-signal training scenario as shown in FIG. 4, comprising:
S11: As shown in FIG. 3, define the longitudinal motion of vehicles in the interactive multi-lane multi-traffic-signal training scenario using a vehicle kinematics model:

$$[ \begin{matrix}{x}^{′} \\ {v}^{′}\end{matrix} ] = [ \begin{matrix}0 & 1 \\ 0 & 0\end{matrix} ] [ \begin{matrix}x \\ v\end{matrix} ] + [ \begin{matrix}0 \\ 1\end{matrix} ] a$$

Where x and v are the longitudinal position and velocity of the vehicle, x′ and v′ are their first-order derivatives, and a is the acceleration.
S12: Simplify the lane-changing process into an instantaneous transition in the interactive multi-lane multi-traffic-signal training scenario.
S13: Define traffic signals as having multiple phases, where different phases grant varying right-of-way permissions to different lanes.
S14: Implement a rule-based longitudinal acceleration decision model for other vehicles. To enable reactive responses to environmental changes, other vehicles are assigned a rule-based longitudinal acceleration decision model, comprising:
S141: The decision model for other vehicles outputs a maximum safe speed v_{safe} based on preceding vehicle and traffic light information:

$${v}_{safe} = min ( \sqrt{( \frac{{{v}_{l}}^{2}}{2 {b}_{max}} + {d}_{gap} ) \cdot 2 {b}_{max} ,} \sqrt{2 {b}_{max} {d}_{tl}} )$$

where vₗ is the preceding vehicle's speed, bₘₐₓ is the maximum deceleration, d_{gap} is the inter-vehicle distance, and dₜₗ is the distance to the traffic light. All vehicles have a length of 5 meters and an acceleration range of [−4.5,2.6] m/s². If no preceding vehicle, traffic light, or green light is present, obtain the corresponding other item to determine the maximum safe speed v_{safe}:
S142: Generate acceleration control commands a based on maximum safe speed, road speed limit, and maximum acceleration:

$$\begin{matrix}{v}_{des} = min ( {v}_{max} , v + {a}_{max} Δ t , {v}_{safe} ) \\ {v}^{′} = min ( 0 , {v}_{des} ) \\ a = {v}^{′} - v\end{matrix}$$

where v_{des} is the expected speed, vₘₐₓ is the road speed limit, v is the vehicle's current speed, aₘₐₓ is the maximum acceleration, Δt is the time step, and v′ is the final target speed.
S15: Implement a rule-based lane-changing decision model for other vehicles. To enable reactive lane changes, other vehicles are assigned a rule-based lane-changing model, comprising:
S151: acquiring lane information and surrounding vehicle data, and screening lane sets Lᵥₐₗ with lane-changing conditions via conditional judgments:

$${L}_{val} = \{ {l}_{i} , ⋯ \}$$

$${δ}_{i} = \{ \begin{matrix}1 & \frac{{{v}_{self}}^{2}}{2 {d}_{max}} \leq \frac{{{v}_{l}}^{2}}{2 {d}_{max}} + {d}_{gap} ⋂ \frac{{{v}_{f}}^{2}}{2 {d}_{max}} \leq \frac{{{v}_{self}}^{2}}{2 {d}_{max}} + {d}_{gap} \\ 0 & \frac{{{v}_{self}}^{2}}{2 {d}_{max}} > \frac{{{v}_{l}}^{2}}{2 {d}_{max}} + {d}_{gap} ⋃ \frac{{{v}_{f}}^{2}}{2 {d}_{max}} > \frac{{{v}_{self}}^{2}}{2 {d}_{max}} + {d}_{gap}\end{matrix}$$

where lᵢ is the lane number, δᵢ indicates whether lane lᵢ meets lane-changing conditions, vₗ is the preceding vehicle speed in lane lᵢ, dₘₐₓ is the maximum deceleration, d_{gap} is the inter-vehicle distance, and v_{f} is the rear vehicle speed in lane lᵢ;
S152: Determine feasible lanes L based on destination lanes Lₜₐᵣ and candidate lanes Lᵥₐₗ:

$$L = {L}_{tar} ⋂ {L}_{val}$$

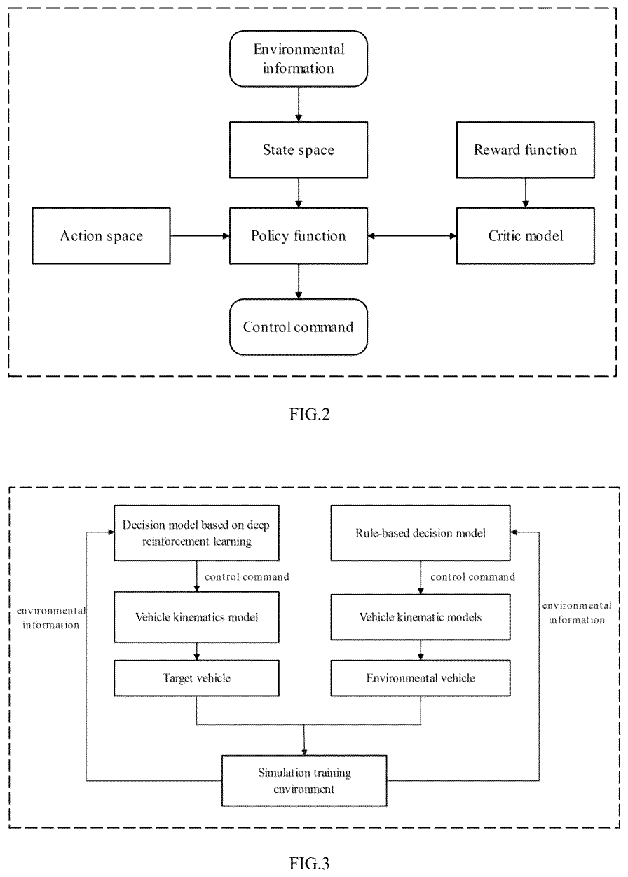

S153: Select the final lane change action lₜₐᵣ based on average lane velocities v̅ᵢ:

$$S = \{ ( {l}_{1} , {\overline{v}}_{1} ) , … , ( {l}_{i} , {\overline{v}}_{i} ) \} , s . t . {l}_{i} ∈ L$$

$${l}_{tar} = \{ {l}_{i} \vert {\overline{v}}_{i} = min \{ \overline{v} \vert ( {l}_{i} , {\overline{v}}_{i} ) ∈ S \} \}$$

where S is the set of lane numbers lᵢ and their corresponding average speeds v̅ᵢ.
S16: Randomize initial positions, velocities, desired speeds of other vehicles, as well as the initial position and velocity of the target vehicle and traffic signal phase timing to ensure environmental stochasticity and prevent collisions.
Step S2: Construct a maximum entropy deep reinforcement learning-based decision model as shown in FIG. 2, comprising:
S21: Constructing the state space S: Build the state space using key traffic environment information, including the target vehicle's velocity, acceleration, and current lane; velocities, lanes, and relative distances of surrounding vehicles within a defined range; relative distance and phase information of front traffic signals; and traffic flow velocity and density for each lane in the upcoming road section.
the state space S is defined as:

$$\begin{matrix}S = [ {S}_{e} , {S}_{others} , {S}_{tl} , {S}_{flow} ] \\ s . t . \\ {S}_{e} = [ {l}_{e} , {v}_{e} , {a}_{e} ] \\ {S}_{others} = [ {d}_{0} , {l}_{0} , {v}_{0} , {d}_{1} , {l}_{1} , {v}_{1} , … , {d}_{5} , {l}_{5} , {v}_{5} ] \\ {S}_{tl} = [ {d}_{tl} , {t}_{red} , {t}_{green} , {t}_{yellow} ] \\ {S}_{flow} = [ {\overline{v}}_{0} , {ρ}_{0} , {\overline{v}}_{1} , {ρ}_{1} , {\overline{v}}_{2} , {ρ}_{2} ]\end{matrix}$$

where: Sₑ is the target vehicle information, Sₒₜₕₑᵣₛ is the surrounding vehicle information, Sₜₗ is the front traffic signal light information, S_{flow} is the front traffic flow information; lₑ, vₐ dₑ respectively denote the lane where the target vehicle is located, its velocity, and acceleration; dᵢ, lᵢ, vᵢ respectively denote the inter-vehicle distance between the surrounding vehicles and the target vehicle, the lanes where the surrounding vehicles are located, and the speeds of the surrounding vehicles; dₜₗ represents the distance to the front traffic signal light, while t_{red},t_{green}, t_{yellow} respectively denote the remaining duration of the red light, green light, and yellow light; v̅ⱼ, ρⱼ represent the average traffic flow speed and traffic density of respective lanes.
S22: Defining the action space A: The action space comprises acceleration and target lane. The acceleration controls longitudinal motion, while the target lane (compared to the current lane) determines lane-changing actions for lateral motion. The action space A is expressed as:

$$\begin{matrix}A = [ a , l ] \\ s . t . a ∈ [ - 4.5 , 2.6 ] m / {s}^{2} , l ∈ [ 0 , 2 ]\end{matrix}$$

where a is the output acceleration, and l is the target lane (numbered 0, 1, 2 for three lanes, from right to left).
S23: Designing the reward function R: The reward function is a weighted sum of five metrics: traffic efficiency, comfort (including Rₐ and R_{a′}), operating cost R_{eco}, and lane change cost R_{lc}.

$$R = {w}_{v} {R}_{v} + {w}_{a} {R}_{a} + {w}_{{a}^{′}} {R}_{{a}^{′}} + {w}_{eco} {R}_{eco} + {w}_{lc} {R}_{lc}$$

where w_{y}, wₐ, w_{a′}, w_{eco}, w_{lc} are weighting coefficients. Traffic efficiency Rᵥ requires the target vehicle's speed to approach the desired speed during operation; comfort demands minimal vehicle acceleration Rₐ and jerk R_{a′}; operating cost R_{eco} necessitates reduced equivalent fuel consumption during driving; lane change cost R_{lc} aims to minimize unnecessary lane-changing behaviors.

Traffic efficiency Rᵥ is expressed as:

$${R}_{v} = {( {v}_{max} - v )}^{2}$$

where vₘₐₓ is the road speed limit, and v is the target vehicle's speed.

Comfort penalizes high acceleration Rₐ and jerk R_{a′}:

$$\begin{matrix}{R}_{a} = {a}^{2} \\ {R}_{{a}^{′}} = {a}^{′2}\end{matrix}$$

where a is the target vehicle's acceleration, and a′ is its rate of change.

Operating cost R_{eco} reflects hybrid electric vehicle (HEV) energy consumption:

$${R}_{eco} = {b}_{1} \cdot v + {b}_{2} \cdot {v}^{2} + {b}_{3} \cdot P + {b}_{4} \cdot {P}^{2} + {b}_{5}$$

Where b is fitting coefficients, and v is the velocity of target vehicle, P is the power demand of target vehicle. This function is the equivalent fuel consumption function for hybrid electric vehicles, which can reflect energy consumption to a certain extent.
lane change cost R_{lc} is represented by the following formula:

$${R}_{lc} = \{ \begin{matrix}1 & if change \\ 0 & if not change\end{matrix}$$

where R_{lc} equals 1 if a lane change occurs, otherwise 0.
S24: Defining policy and critic model architectures: Neural networks approximate the policy model (mapping states to actions) and critic model (evaluating actions by maximizing a weighted sum of rewards and policy entropy).
S25: Storing interaction data: An experience replay buffer stores interaction data. During training, batches are randomly sampled from the buffer, while new data from ongoing interactions are continuously added.

Step S3: Implementing safety constraints for the target vehicle:
S31: Constructing safety constraints for the longitudinal motion of the target vehicle, by employing a rule-based approach, the upper limit of acceleration for the target vehicle under different conditions is derived. The acceleration output by the learning-based decision-making model is compared with the acceleration limit, and the smaller value of the two is taken as the final acceleration control amount.
S311: Compute the maximum safe speed v_{safe}:

$${v}_{safe} = min ( \sqrt{( \frac{{{v}_{l}}^{2}}{2 {b}_{max}} + {d}_{gap} ) \cdot 2 {b}_{max} ,} \sqrt{2 {b}_{max} {d}_{tl}} )$$

where vₗ is the preceding vehicle's speed, bₘₐₓ is the maximum deceleration, d_{gap} is the inter-vehicle distance, and dₜₗ is the distance to the traffic signal. If no preceding vehicle, traffic signal, or green light exists, obtain the corresponding other item to determine the maximum safe speed v_{safe}.
S312: Compute the maximum safe acceleration a_{safe}:

$${a}_{safe} = {v}_{safe} - v$$

S313: Comparing the acceleration a_{policy} output by the DRL model with a_{safe}, and selecting the smaller value as the final acceleration control a:

$$a = min ( {a}_{policy} , {a}_{safe} )$$

S32: Construct safety constraints for the target vehicle's lane change action, by employing a rule-based approach, to judge the target lane output by the learning-based decision model. If the lane change action is within the safety constraints, then proceed with the lane change; otherwise, do not perform the lane change.
S321: Judging the target lane l_{policy} output by the DRL model:

$${δ}_{policy} = \{ \begin{matrix}1 & \frac{{{v}_{self}}^{2}}{2 {d}_{max}} \leq \frac{{{v}_{l}}^{2}}{2 {d}_{max}} + {d}_{gap} ⋂ \frac{{{v}_{f}}^{2}}{2 {d}_{max}} \leq \frac{{{v}_{self}}^{2}}{2 {d}_{max}} + {d}_{gap} \\ 0 & \frac{{{v}_{self}}^{2}}{2 {d}_{max}} > \frac{{{v}_{l}}^{2}}{2 {d}_{max}} + {d}_{gap} ⋃ \frac{{{v}_{f}}^{2}}{2 {d}_{max}} > \frac{{{v}_{self}}^{2}}{2 {d}_{max}} + {d}_{gap}\end{matrix}$$

Where δ_{policy} indicates whether lane l_{policy} meets lane-changing conditions, vₗ is the preceding vehicle's speed, bₘₐₓ is the maximum deceleration, d_{gap} is the inter-vehicle distance, and v_{f} is the rear vehicle speed in lane l_{policy}.
S322: If δ_{policy}=1, execute the lane change; otherwise, prohibit it.

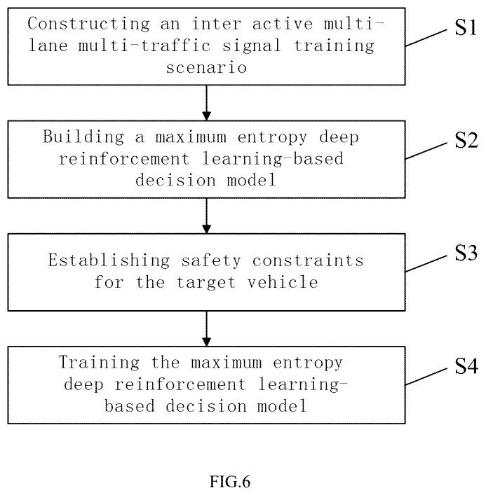

Step S4: As shown in FIG. 5, training the maximum entropy DRL decision model, comprising:
S41: Initializing the maximum entropy DRL decision model, including hyperparameters of the policy model and critic model;
S42: Adding the target vehicle to the training environment, generating interactive training data (sₜ, aₜ, rₜ, sₜ₊₁) under safety constraints, and storing the data in an experience replay buffer; S43: Extracting training data from the buffer and updating two critic models via gradient descent:

$${∇}_{{θ}_{i}} \frac{1}{\vert M \vert} {\sum }_{( {s}_{t} , {a}_{t} , {r}_{t} , {s}_{t + 1} ) ∈ M} {( {Q}_{i} ( {s}_{t} ) - y ( {r}_{t} , {s}_{t + 1} ) )}^{2} , for i = 1 , 2$$

$$y ( {r}_{t} , {s}_{t + 1} ) = {r}_{t} + γ ( {min}_{j = 1 , 2} {Q}_{tar - j} ( {s}_{t + 1} ) - α log π ( {\tilde{a}}_{t + 1} \vert {s}_{t + 1} ) , {\tilde{a}}_{t + 1} \sim π ( \cdot \vert {s}_{t + 1} )$$

where M is the number of sampled data points, |M| is the batch size, sₜ,aₜ,rₜ represent the state, action, reward, and next state at time t, Qᵢ is the i-th critic model, θᵢ is its parameters, y(·) is the prediction of the values of the critic model, Qₜₐᵣ₋ⱼ is the j-th target critic, π(·|sₜ) is the policy, ãₜ₊₁ is the next action sampled from sₜ₊₁, α is the temperature coefficient, and γ is the discount factor;
S44: Updating the policy model via gradient descent:

$${∇}_{ψ} \frac{1}{\vert M \vert} {\sum }_{{s}_{t} ∈ M} ( {min}_{j = 1 , 2} {Q}_{tar - j} ( {s}_{t} ) - α log π ( {\tilde{a}}_{t} \vert {s}_{t} ) )$$

Where Ψ is the policy parameters; ãₜ is the action sampled from sₜ;
S45: Updating the temperature coefficient via gradient descent:

$${∇}_{α} \frac{1}{\vert M \vert} {\sum }_{{s}_{t} , {a}_{t} ∈ M} ( - α log π ( {a}_{t} \vert {s}_{t} ) - α {H}_{0} )$$

Where α is the temperature coefficient, H₀ is the target entropy;
S46: Updating the two target critic models:

$${θ}_{tar , i} = {ρθ}_{tar , i} + ( 1 - ρ ) {θ}_{i} , for i = 1 , 2$$

Where ρ is the soft update coefficient; θ_{tar,i} is the parameters of the target critic Qₜₐᵣ₋ᵢ, and θᵢ is the parameters of the critic model Qᵢ;
S47: Iteratively training the maximum entropy DRL model until convergence. If performance is unsatisfactory, optimizing hyperparameters and the reward function, and returning to S41. The hyperparameters of the final model are shown in Table 1.

TABLE 1
Hyperparameter Values

| Hyperparameter | Value |
|---|---|
| Learning rate | 0.0005 |
| Discount factor γ | 0.99 |
| Soft update coefficient ρ | 0.002 |
| Replay buffer size | 10000000 |
| Minimum batch size | 1024 |
| Target entropy H₀ | −2 |

Finally, it is noted that the above embodiments are illustrative and not restrictive. Modifications or equivalents may be made by those skilled in the art without departing from the scope of the invention as defined in the appended claims.

1. A networked new energy automobile economical driving method oriented to complex traffic scene, comprising:
S1: constructing an interactive multi-lane, multi-traffic signal simulation training environment, wherein:
longitudinal motion of vehicles is described by a kinematic model;
lane-changing is simplified as a transient process;
traffic signals operate in multiple phases;
rule-based longitudinal acceleration decision models and lane-changing decision models for surrounding vehicles are established to enable reactive responses to traffic environment changes;
wherein the kinematic model is expressed as:
$$[ \begin{matrix}{x}^{′} \\ {v}^{′}\end{matrix} ] = [ \begin{matrix}0 & 1 \\ 0 & 0\end{matrix} ] [ \begin{matrix}x \\ v\end{matrix} ] + [ \begin{matrix}0 \\ 1\end{matrix} ] a$$
where x and v represent the vehicle's longitudinal position and velocity, x′ and v′ represent the first derivatives of longitudinal position and velocity, respectively, and a represents acceleration;
wherein the rule-based longitudinal acceleration decision model for surrounding vehicles comprises:
1) calculating a maximum safe speed v_{safe};
$${v}_{safe} = min ( \sqrt{( \frac{{v}_{l}^{2}}{2 {b}_{max}} + {d}_{gap} ) \cdot 2 {b}_{max}} , \sqrt{2 {b}_{max} {d}_{tl}} )$$
where vₗ is the preceding vehicle's speed, bₘₐₓ is the vehicle's maximum deceleration, d_{gap} is the inter-vehicle distance, and dₜₗ is the distance to the traffic signal;
2) outputting the vehicle's acceleration a based on v_{safe}, road speed limit, and vehicle maximum acceleration:
$${v}_{d e s} = min ( {v}_{max} , v + {a}_{max} Δ t , {v}_{safe} )$$
$${v}^{′} = min ( 0 , {v}_{des} )$$
$$a = {v}^{′} - v$$
where v_{des} is the expected speed, vₘₐₓ is the road speed limit, v is the vehicle's current speed, aₘₐₓ is the maximum acceleration, Δt is the time step, and v′ is the final target speed;
wherein the rule-based lane-changing decision model for surrounding vehicles comprises:
1) acquiring lane information and surrounding vehicle data, and screening lane sets Lᵥₐₗ with lane-changing conditions via conditional judgments:
$${L}_{v a l} = \{ {l}_{i} , … \}$$
$${δ}_{i} = \{ \begin{matrix}1 & \frac{{v}_{self}^{2}}{2 {d}_{max}} \leq \frac{{v}_{l}^{2}}{2 {d}_{max}} + {d}_{gap} ⋂ \frac{{v}_{f}^{2}}{2 {d}_{max}} \leq \frac{{v}_{self}^{2}}{2 {d}_{max}} + {d}_{gap} \\ 0 & \frac{{v}_{self}^{2}}{2 {d}_{max}} > \frac{{v}_{l}^{2}}{2 {d}_{max}} + {d}_{gap} ⋃ \frac{{v}_{f}^{2}}{2 {d}_{max}} > \frac{{v}_{self}^{2}}{2 {d}_{max}} + {d}_{gap}\end{matrix}$$
where lᵢ is the lane number, δᵢ indicates whether lane/meets lane-changing conditions, dₘₐₓ is the maximum deceleration, v_{f} is the rear vehicle speed in lane lᵢ and v_{self} is the current speed of the vehicle;
2) determining feasible lanes Lₜₐᵣ based on the destination and combining with Lᵥₐₗ to obtain final executable lanes L;
$$L = {L}_{tar} ∩ {L}_{val}$$
3) determining the final lane-changing action lₜₐᵣ based on average lane speeds v̅ᵢ:
$$S = \{ ( {l}_{1} , \overline{{v}_{1}} ) , … , ( {l}_{i} , \overline{{v}_{i}} ) \} , s . t . {l}_{i} ∈ L$$
$${l}_{t a r} = \{ {l}_{i} \vert \overline{{v}_{i}} = min \{ \overline{v} \vert ( {l}_{i} , \overline{{v}_{i}} ) ∈ S \} \}$$
where S is the set of lane numbers lᵢ and their corresponding average speeds v̅ᵢ;
S2: building a maximum entropy deep reinforcement learning (DRL) decision model, including:
a state space, an action space, and a reward function;
setting structures of a policy model and a critic model, wherein the policy model maps states to actions, and the critic model evaluates actions generated by the maximum entropy DRL model;
wherein the state space is defined as:
$$S = [ {S}_{e} , {S}_{o t h e r s} , {S}_{tl} , {S}_{flow} ]$$
$$s . t .$$
$${S}_{e} = [ {l}_{e} , {v}_{e} , {a}_{e} ]$$
$${S}_{o t h e r s} = [ {d}_{0} , {l}_{0} , {v}_{0} , {d}_{1} , {l}_{1} , {v}_{1} , … , {d}_{5} , {l}_{5} , {v}_{5} ]$$
$${S}_{tl} = [ {d}_{t l} , {t}_{red} , {t}_{green} , {t}_{yellow} ]$$
$${S}_{flow} = [ {\overline{v}}_{0} , {ρ}_{0} , \overline{{v}_{1}} , {ρ}_{1} , {\overline{v}}_{2} , {ρ}_{2} ]$$
where: Sₑ is the target vehicle information, Sₒₜₕₑᵣₛ is the surrounding vehicle information, Sₜₗ is the front traffic signal light information, S_{flow} is the front traffic flow information; lₑ, vₐ, aₑ respectively denote the lane where the target vehicle is located, its velocity, and acceleration; dᵢ, lᵢ, vᵢ respectively denote the inter-vehicle distance between the surrounding vehicles and the target vehicle, the lanes where the surrounding vehicles are located, and the speeds of the surrounding vehicles;_ dₜₗ represents the distance to the front traffic signal light, while t_{red},t_{green}, t_{yellow} respectively denote the remaining duration of the red light, green light, and yellow light; v̅j, ρⱼ represent the average traffic flow speed and traffic density of respective lanes;
the action space is defined as:
$$A = [ a , l ]$$
$$s . t . a ∈ [ - 4.5 , 2.6 ] m / {s}^{2} , l ∈ [ 0 , 2 ]$$
where l is the target lane;
the reward function is defined as:
$$R = {w}_{v} {R}_{v} + {w}_{a} {R}_{a} + {w}_{{a}^{′}} {R}_{{a}^{′}} + {w}_{e c o} {R}_{e c o} + {w}_{l c} {R}_{l c}$$
where wᵥ, wₐ, w_{a′}, w_{eco}, w_{lc} are weighting coefficients, Rᵥ rewards traffic efficiency, Rₐ and R_{a′}penalize acceleration and jerk, R_{eco} penalizes energy consumption, and R_{lc} penalizes lane changes;
S3: applying safety constraints to the target vehicle, including:
longitudinal motion safety constraints;
lane-changing action safety constraints;
wherein the longitudinal motion safety constraints comprise:
1) calculating the maximum safe speed v_{safe}:
$${v}_{safe} = min ( \sqrt{( \frac{{v}_{l}^{2}}{2 {b}_{max}} + {d}_{gap} ) \cdot 2 {b}_{max}} , \sqrt{2 {b}_{max} {d}_{tl}} )$$
2) calculating the maximum safe acceleration a_{safe}:
$${a}_{safe} = {v}_{safe} - v$$
3) comparing the acceleration a_{policy} output by the DRL model with a_{safe}, and selecting the smaller value as the final acceleration control a:
$$a = min ( {a}_{policy} , {a}_{safe} ) ;$$
wherein the lane-changing safety constraints comprise:
judging the target lane l_{policy} output by the DRL model:
$${δ}_{policy} = \{ \begin{matrix}1 & \frac{{v}_{self}^{2}}{2 {d}_{max}} \leq \frac{{v}_{l}^{2}}{2 {d}_{max}} + {d}_{gap} ⋂ \frac{{v}_{f}^{2}}{2 {d}_{max}} \leq \frac{{v}_{self}^{2}}{2 {d}_{max}} + {d}_{gap} \\ 0 & \frac{{v}_{self}^{2}}{2 {d}_{max}} > \frac{{v}_{l}^{2}}{2 {d}_{max}} + {d}_{gap} ⋃ \frac{{v}_{f}^{2}}{2 {d}_{max}} > \frac{{v}_{self}^{2}}{2 {d}_{max}} + {d}_{gap}\end{matrix}$$
where δ_{policy} indicates whether lane l_{policy} meets lane-changing conditions; if δ_{policy}=1, execute the lane change; otherwise, prohibit it and v_{self} is the current speed of the vehicle;
S4: training the maximum entropy DRL decision model, wherein S4 further comprising:
S41: initializing the maximum entropy DRL decision model, including hyperparameters of the policy model and critic model;
S42: adding the target vehicle to the training environment, generating interactive training data (sₜ, aₜ, rₜ, sₜ₊₁) under safety constraints, and storing the data in an experience replay buffer;
S43: extracting training data from the buffer and updating two critic models via gradient descent:
$${∇}_{{θ}_{1}} \frac{1}{\vert M \vert} {\sum }_{( {s}_{t} , {a}_{t} , {r}_{t} , {s}_{t + 1} ) ϵM} {( {Q}_{i} ( {s}_{t} ) - y ( {r}_{t} , {s}_{t + 1} ) )}^{2} , for i = 1 , 2$$
$$y ( {r}_{t} , {s}_{t + 1} ) = {r}_{t} + γ ( {min}_{j = 1 , 2} {Q}_{tar - j} ( {s}_{t + 1} ) - α log π ( {\tilde{a}}_{t + 1} \vert {s}_{t + 1} ) , {\tilde{a}}_{t + 1} ∼ π ( \cdot \vert {s}_{t + 1} )$$
where M is the number of sampled data points, |M| is the batch size, sₜ, aₜ, rₜ represent the state, action, reward, and next state at time t, Qᵢ is the i-th critic model, θᵢ it its parameters, γ(·) is the prediction of the values of the critic model, Qₜₐᵣ₋ⱼ is the j-th target critic, π(·|sₜ) is the policy, ãₜ₊₁ is the next action sampled from sₜ₊₁, α is the temperature coefficient, and γ is the discount factor;
S44: updating the policy model via gradient descent:
$${∇}_{ψ} \frac{1}{\vert M \vert} {\sum }_{{s}_{t} ∈ M} ( {min}_{j = 1 , 2} {Q}_{tar - j} ( {s}_{t} ) - α log π ( {\tilde{a}}_{t} \vert {s}_{t} ) )$$
where Ψ is the policy parameters; ãₜ is the action sampled from sₜ;
S45: updating the temperature coefficient via gradient descent:
$${∇}_{a} \frac{1}{\vert M \vert} {\sum }_{{s}_{t} , {a}_{t} ∈ M} ( - α log π ( {a}_{t} \vert {s}_{t} ) - α {H}_{0} )$$
where H₀ is the target entropy;
S46. updating the two target critic models:
$${θ}_{tar , i} = p {θ}_{tar , i} + ( 1 - ρ ) {θ}_{i} , for i = 1 , 2$$
where ρ is the soft update coefficient; θ_{tar,j} is the parameters of the target critic Qₜₐᵣ₋ᵢ, and θᵢ is the parameters of the critic model Qᵢ;
S47: iteratively training the maximum entropy DRL model until convergence; if performance is unsatisfactory, optimizing hyperparameters and the reward function, and returning to S41.

2-8. (canceled)
